(19) United States
(12) Patent Application Publication
(10) Pub. No.: US 2021/0031396 A1
(43) Pub. Date: Feb. 4, 2021

(54) PACKAGING MACHINE HAVING CUTTING STATION

(71) Applicant: MULTIVAC SEPP HAGGENMUELLER SE & CO. KG, Wolfertschwenden (DE)

(72) Inventors: Nick NOBIS, Kempten (DE); Maximilian HETZ, Haldenwang (DE)

(73) Assignee: MULTIVAC SEPP HAGGENMUELLER SE & CO. KG, Wolfertschwenden (DE)

(21) Appl. No.: 16/943,146

(22) Filed: Jul. 30, 2020

(30) Foreign Application Priority Data
Jul. 30, 2019 (DE) 102019211335.4

(51) Int. Cl. B26D 1/25; B65B 61/06; B26D 1/00; B26F 1/38

(52) U.S. Cl. CPC B26D 1/255; B65B 61/06; B26D 2210/11; B26F 1/384; B26D 2001/004; B26D 1/0006

(57) ABSTRACT

A packaging machine having a plurality of working stations for processing a film, at least one of the working stations being a cutting station. The working stations are disposed successively along a working direction and the film is conveyed in the working direction from a first one of the working stations to a second one of the working stations. The cutting station is configured to sever the film in a cutting direction, which is oriented transverse, preferably orthogonal, with respect to the working direction. The cutting station has a knife and counter pressure device, both being pressable against one another in a pressing direction. The disclosure is characterized in that the counter pressure device has a curved surface, which is curved around a curvature axis, and the counter pressure device is configured to roll on a cutting edge of the knife about a rolling axis with the curved surface.

### CROSS-REFERENCE TO RELATED APPLICATIONS

This application claims foreign priority benefits under 35 U.S.C. § 119(a)-(d) to European patent application number DE 10 2019 211 335.4, filed Jul. 30, 2019, which is incorporated by reference in its entirety.

### TECHNICAL FIELD

The disclosure is directed to a packaging machine according to the disclosure.

### BACKGROUND

Packaging machines, which generate packages by processing one or more films, are known. Frequently, an upper film is heat bonded to a container, in which a product is accommodated. The container may be formed in an additional film, for example a lower film. Often, the lower film as well as the upper film are provided as long (quasi-endless) sheets, which extend in a production direction and are conveyed in this production direction through various working stations, whereby numerous packages may be manufactured. It is also known to close several single tray like containers using a long film sheet. In both cases a plurality of closed packages are formed, which are connected to each other by the upper film or by the upper and the lower film.

In order to generate individual packages or package groups having a defined number of interconnected packages, the upper film and if applicable the lower film have to be severed. So-called transverse cutting devices, which sever the film to be cut between successively close packages, have proven practicable. Here, a cut running orthogonal to the production direction is effected.

In DE 10 2010 019 634 B3 a cutting device for a packaging machine is disclosed. Therein, it is mentioned that while severing in particular thick or strong films, high forces have to be generated. As an improvement, a modified lifting mechanism is proposed, which reduces maintenance efforts of the drive. The forces being active at the knife itself are not changed because the cut is still executed by a straight knife, whereby the contact area between the blade of the knife and the film is line shaped, i.e., the severance occurs simultaneously in a line shaped portion.

### SUMMARY

Therefore, it is an object of the disclosure to provide a packaging machine, which is improved with respect to its efficiency. This object is achieved by a packaging machine according to the disclosure. Further advantageous embodiments are set forth in the disclosure.

The disclosure provides a packaging machine having a plurality of working stations for processing a film, at least one of the working stations being a cutting station. The working stations are disposed successively along a working direction and the film is conveyed in the working direction from a first one of the working stations to a second one of the working stations. The cutting station is configured to sever the film in a cutting direction, which is oriented transverse, preferably orthogonal, with respect to the working direction, wherein the cutting station has a knife and a counter pressure device, which are pressable against one another in a pressing direction. The packaging machine is characterized in that the counter pressure device has a curved surface, which is curved around a curvature axis and the counter pressure device is configured to roll on a cutting edge of the knife about a rolling axis with the curved surface.

Whenever a pressing is mentioned in connection with the counter pressure device, this should be construed as processes, in which the entire counter pressure device or merely parts and/or components of a counter pressure device and the respective pressing partner or pressing partners are pressed against one another. Similarly, the provision of a curved surface at the counter pressure device is also to be understood such that this curved surface may be provided at a part and/or component of the counter pressure device.

The curvature of the curved surface may be circular or elliptical. All points on the curved surface may have identical distances to the curvature axis. Directions oriented in an angle with respect to a given direction may be considered as being oriented transverse to said given direction. This angle may be larger than 0°, in particular larger than 15° or 30° or 45°, particularly preferred 90°. An upper film and/or a lower film may be considered a film. Further, a composite of two or more films, for example an upper and a lower film, bonded to each other, preferably during the packaging process, may be considered as a film.

The verb “to cut” and any terms derived from it are to be understood as synonymous with “to sever” and corresponding derived terms with respect to the present application. Therefore, whenever a cutting of the film is mentioned, not only the technical process of cutting is encompassed but any kind of process suitable for severing the film. Further, devices, which are configured not only for cutting but also for severing in any kind of way are to be considered cutting devices, in particular cutting stations.

A knife having a cutting edge may in particular be understood as a structure which is configured to sever a film, when said film is pressed against the cutting edge. The severance may comprise not only a cutting process but alternatively or additionally any kind of severance, for example it may comprise a squeezing off or, using a heated knife, a melting of the film. Accordingly, any kind of edge or similar structure of the knife, which is suitable for the severance the film by pressing against it may be considered a cutting edge.

By rolling of the counter pressure device on the cutting edge of the knife, it may be achieved that at any point in time during the cut, only a small, preferably point shaped, portion of the film is pressed against the cutting edge and thereby severed. The pressing force necessary for this may be substantially lower than if the knife is pressed against the film with the entire cutting edge at the same time.

By reducing the forces occurring at the knife itself compared to conventional solutions, the maintenance effort for the drive may be reduced on one hand. On the other hand, cost savings may be achieved on the knife itself because it may be designed less robust and/or less stably supported and/or re-sharpened and/or switched less often. In other words, the operating time of the knife may be prolonged. If applicable, complex lifting mechanisms, such as the one shown in DE 10 2010 019 634 B3, may not be necessary. All of these factors may increase the efficiency of a packaging machine and/or may decrease production and/or operating costs.

It is conceivable that the rolling axis is at least partially oriented parallel to the working direction. If this is the case. Severing processes may be executed transverse and/or orthogonal to the working direction. The rolling axis may be considered as oriented partially parallel to the cutting edge if this is the case along a portion of the cutting edge.

In at least one embodiment, the rolling axis may be oriented at least partially transverse, and in at least another embodiment orthogonal, to the cutting edge. This may entail the advantage that the portion of the film being pressed against the cutting edge may be kept as small as possible. The rolling axis may be considered as oriented partially transverse and/or orthogonal to the cutting edge if this is the case along a portion of the cutting edge. Because knives having a non-straight cutting edge are known, for example to impart certain contours onto packages or packaging flanges, it is conceivable that the rolling axis is oriented orthogonal to the cutting edge in a first portion along the cutting edge and is oriented in another angle or parallel to the cutting edge along a second portion of the cutting edge.

The rolling axis may for example be oriented parallel, and in one embodiment collinear, to the curvature axis.

In an advantageous variant, the knife is immovable in the pressing direction with respect to the film and/or with respect to a machine frame of the packaging machine and/or with respect to a frame of the cutting station. Thereby, a number of movable parts of the cutting station may be reduced, which may simplify construction and reduce wear.

It is advantageous when a contact surface between the curved surface and the cutting edge is point shaped during rolling. Thereby, a pressing force between the knife and the counter pressure device necessary for severing the film may be further reduced. It is particularly advantageous if a contact surface between the curved surface and the cutting edge moves along the cutting edge during rolling.

The pressing direction may be oriented orthogonal with respect to the working direction and the cutting direction. This may enable a particularly efficient severance of the film. In particular in cases in which the counter pressure device is located between packaging depressions during pressing of the film against the cutting edge, such a configuration may enable the counter pressure device to be removed from the cutting edge and out of the space between the packaging depressions in a single movement, such that conveying of the packaging depressions is not blocked by the counter pressure device. This is analogously applicable to the pressing of the counter pressure device onto the cutting edge of the knife.

In a further advantageous variant, the counter pressure device may be configured such that the rolling axis moves relative to the knife during rolling. In this way, it may be achieved that slippage between the counter pressure device and the cutting edge is reduced as far as possible or preferably eliminated.

It is conceivable that the counter pressure device comprises a roller, preferably a cylindrical roller, on which the curved surface is provided. This may enable a particularly simple manufacturing process. For example, the roller may be manufactured by simple turning processes. Off-the-shelf bearings, in particular rolling bearings or friction bearings having an outer ring made of metal, may be provided for bearing the roller. It is conceivable that an outer ring of a rolling or friction bearing is used as the roller and/or that the curved surface is provided on an outer ring of the bearing. In such a case, the term “roller” as used in the present application may be understood to refer to an outer ring of a bearing.

The counter pressure device may for example have an actuator, which is configured to press the roller against the knife. In embodiments, in which a plurality of rollers is provided, for example in order to execute several cuts simultaneously, every roller may advantageously have an actuator assigned to it for pressing the respective roller onto the cutting edge of the knife. An actuator for pressing the roller may also be beneficial because the pressing force may be selectively controllable, for example in order to be adjustable to different film thicknesses. Any body on which a curved surface is provided circumferentially may be considered as a roller. This may mean that the body having the curved surface is rollable on the cutting edge by a rolling angle of more than 360° about the rolling axis, preferably without the need to interrupt the rolling. The rolling angle may be defined as the angle, about which the roller rotates during rolling.

In one embodiment, the counter pressure device may be movable transverse to the working direction. In particular a linear movement is conceivable, during which the roller may roll on the cutting edge of the knife in a state in which it is pressed against the cutting edge of the knife. This may enable particularly simple kinematics and, therefore, a cost efficient build of the cutting station.

In a further advantageous variant, the counter pressure device may comprise a rocker, on which the curved surface is provided a body on which the curved surface is not provided circumferentially may be considered a rocker. The shape of the rocker may limit a rolling angle, about which the rocker is rollable on the curved surface. The rolling angle may here be defined as the angle, by which the rocker rotates during rolling. The rolling angle may for example be limited to less than 180 preferably less than 90°, particularly preferred to less than 45°.

A rocker may make it possible that in a single severing action, every portion of the curved surface comes into contact with the knife only once, while using a roller, a given portion of the curved surface may contact the cutting edge of the knife several times during a single severing action because of the rotation by more than 360°. Accordingly, the rocker may reduce the wear on the curved surface of the counter pressure device. Further, a levering effect may be achieved by the rocker, which may reduce the forces necessary for operating the rocker.

It is conceivable that the counter pressure device has two actuators, which are configured to press the rocker against the knife. Said actuators may for example engage at opposite end portions of the rocker. The actuators may advantageously be configured to generate the rolling motion of the rocker. For this purpose, they may be controllable such that firstly, a first of the two end portions of the rocker is pressed against the knife and the rocker rolls in a rocking movement on the cutting edge with the curved surface until the second of the two end portions of the rocker is pressed against the knife. A plurality of rockers may be provided. It is conceivable that several, particularly all rockers are interconnected and are movable by two actuators as described above. This may reduce the number of actuators. However, it is also conceivable that each of the rockers is movable by two actuators as described above. This may enable the movement and the pressing force of each single rocker to be selectively controllable.

### BRIEF DESCRIPTION OF THE DRAWINGS

The disclosure is directed to a packaging machine of the type described above. In the following, advantageous embodiments will be described with reference to drawings.

FIG. 1 shows a schematic side view of a packaging machine;

FIG. 2 shows a perspective view of the cutting station according to a first embodiment;

FIG. 3 shows the view from FIG. 2, wherein the counter pressure device has been shifted relative to the cutting station;

FIG. 4 shows a detailed view of components of the counter pressure device according to the first embodiment from a perspective oriented opposite the cutting direction;

FIG. 5 shows a sectional view of components from FIG. 4 from a similar perspective;

FIG. 6 shows a sectional view of further components from FIG. 4 from a similar perspective;

FIG. 7 shows a perspective view of the cutting station according to a second embodiment;

FIG. 8 shows a perspective view of a rocker and a knife;

FIG. 9 shows a side view of the cutting station from FIG. 7 from a perspective oriented opposite the working direction, wherein the rocker is shown in a position prior to a rocking movement;

FIG. 10 shows a side view cutting station from FIG. 7 from a perspective oriented opposite the working direction, wherein the rocker is shown in a position after a rocking movement;

FIG. 11 shows a detailed view of components of the counter pressure device according to the second embodiment from a perspective oriented opposite the cutting direction; and

FIG. 12 shows a schematic view of the rocker intended to illustrate the rolling axis of the rocker and the curvature axis of the curved surface provided on the rocker.

### DETAILED DESCRIPTION

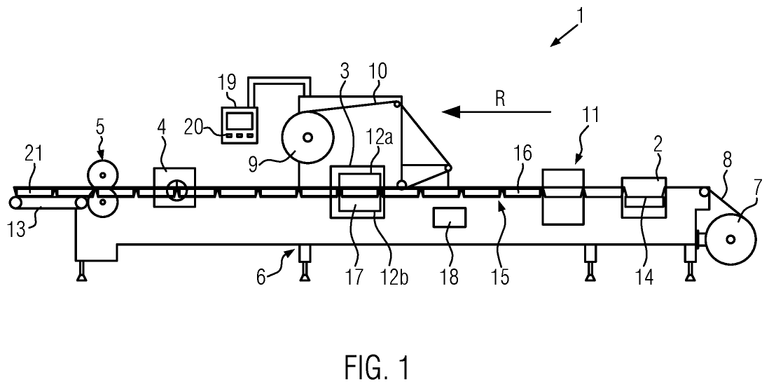

FIG. 1 shows a schematic view of a packaging machine 1, which may be a deep drawing packaging machine. The packaging machine 1 may have one or more working stations, in particular, as in the shown embodiment, a forming station 2, a sealing station 3, a transverse cutting device 4 and a longitudinal cutting device 5. It should be appreciated, that the packaging machine may have one or more of the listed working stations. These may be arranged in the above-mentioned sequence along a working direction R at a machine frame 6. Further, a leakage detection station 11 may be arranged downstream of the forming station 2 as a further working station.

At an input side a feed roll 7 may be provided at the machine frame 6. Said feed roll 7 may have a first film 8 pulled off of it. In the area of the sealing station 3, a film stock 9 may be provided, of which a second film 10 may be pulled as a cover film. At a discharge side, a discharge device 13 for example a transport belt may be provided at the packaging machine, with which individualized packages may be discharged. Further, the packaging machine 1 may have a feeding device, which is not shown and which may grip the film 8 and transport it, preferably in an indexed manner in the working direction R. The feeding device may be realized for example by laterally arranged transport chains, preferably clamping chains.

As shown in the embodiment, the forming station 2 may be embodied as a deep drawing station. Therein, one or more packaging depressions 14 may be formed into the first film 8 by deep drawing. The forming station 2 may be adapted such that a plurality of packaging depressions may be formed next to each other in a direction orthogonal to the working direction R. Downstream of the forming station 2 with respect to the working direction R, a filling lane 15 may be provided. There, the packaging depressions 14 formed in the first film 8 may be filled with product 16.

The sealing station 3 may comprise an upper tool 12a and a lower tool 12b. These may be configured to form a gastightly sealable chamber 17, in which an atmosphere inside the packaging depressions 14 may be modified prior to sealing, for example by evacuation and/or gas flushing with an exchange gas or with an exchange gas mixture.

The longitudinal cutting device 5 may, as in the shown embodiment, be embodied as a rotary circular knife assembly, with which the first film 8 and the second film 10 may be cut between neighboring packaging depressions 14 and at the lateral edge of the first film 8, whereby behind the longitudinal cutting device 5, individualized packages may be present. The transverse cutting device 4 and the longitudinal cutting device 5 may each be considered a working station, in particular a cutting station, or may be considered jointly as a working station, in particular a cutting station. In the following, two embodiments of the transverse cutting device 4 will be explained in more detail as transverse cutting device 4 and transverse cutting device 104.

The packaging machine 1 may further comprise a control unit 18. It may be configured to control and/or monitor the processes running in the packaging machine 1. In addition, a display 19, preferably having operating elements 20, may be provided and adapted for visualizing and/or influencing processes in the packaging machine 1 by an operator.

The general operation of the packaging machine 1 may occur as briefly explained in the following.

The first film 8 may be pulled off the feed roll 7 and be transported by the feeding device into the forming station 2. In the forming station 2, one or more packaging depressions 14 may be formed into the first film 8 by deep drawing. The packaging depressions 14 may be indexed in a main working tact together with surrounding portions of the first film 8 to the leakage detection station 11. There, they may be checked for leakages, which may have occurred during forming for example. Afterwards, the packaging depressions 14 may be transported to the filling lane 15, where they may be filled with product 16.

Afterwards, the filled packaging depressions 14, together with the portion of the first film 8 surrounding them, may be transported to the sealing station 3 by the feeding device. In the sealing station 3, the second film 10 may be sealed as a cover film to the first film 8. Subsequently, the second film 10 may be transported by the feeding movement of the first film 8. Here, the second film 10 may be pulled off the film stock 9. Sealed packages 21 may be formed by sealing the cover film 10 to the packaging depressions 14. In the cutting devices 4, 5 the packages 21 may be individualized by cutting the films 8, 10 in transverse and longitudinal directions, respectively. A direction oriented substantially parallel to the working direction R may be considered a longitudinal direction.

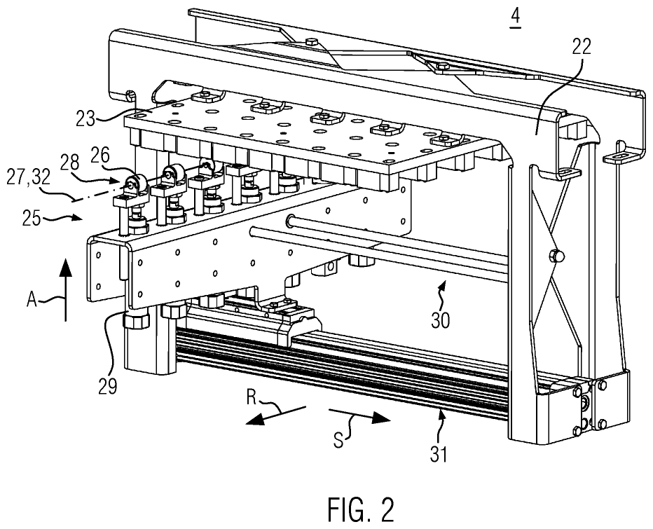

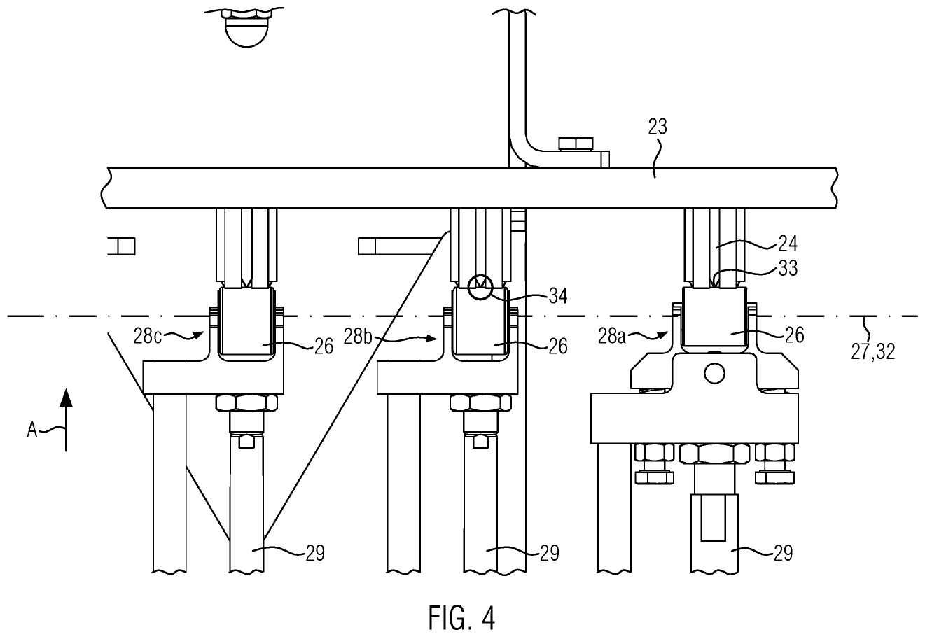

In FIG. 2, the transverse cutting device 4, also referred to as the cutting station 4 in the following, is respectively shown. As shown, it may have a frame 22. Said frame 22 may allow for conveying the film 8 and/or a film composite comprising the first film 8 and the second film 10 in the working direction R through the frame 22. A knife plate 23 may be arranged at the frame 22. Said knife plate 23 may be configured to hold one or a plurality of knives 24 (see FIG. 4). The cutting station 4 may further comprise a counter pressure device 25. Depending on whether one or a plurality of knives 24 are provided, the one or the plurality of knives 24 and the counter pressure device 25 may be pressable against one another. The pressing may occur in a pressing direction A. The packaging machine 1, in particular the cutting station 4 may be configured such that the first film 8 and/or the second film 10 are conveyed between the knife 24 or the knives 24 and the counter pressure device 25. The cutting device 4 may be configured to press the first film 8 and/or the second film 10 against the knives 24 by pressing the counter pressure device 25 and the knives 24 against one another. Thereby, the first film 8 and/or the second film 10 may be severed.

The counter pressure device 25 may have a curved surface 26. The curved surface 26 may be curved around a curvature axis 27. The curvature may be circular or elliptical. As in the embodiment shown in FIG. 2, the curved surface 26 may be curved circular. For example, the curved surface 26 may be provided at a cylindrical roller 28. The counter pressure device 25 may comprise the roller 28.

It should be appreciated that even though several knives 24 and several rollers 28 are provided in the present embodiment, cutting stations having only one knife and/or only one roller are encompassed by the disclosure as well.

The counter pressure device 25, in particular the roller 28 may be pressable against the knife 24 for this purpose, the counter pressure device may, as in the presently described embodiment, comprise an actuator 29. The latter may be configured for pressing the roller 28 against the knife 24. The actuator 29 may for example be a pneumatic cylinder. The cutting station for may be configured to sever the first film 8 and/or the second film 10 in a cutting direction S. For this purpose, the cutting station 4 may comprise a linear guide 30. The counter pressure device 25 may engage the linear guide 30. Accordingly, a movement of the counter pressure device 25 may be guided in this way. The cutting station 4 may further comprise a feeding actuator 31. The feeding actuator 31 may be configured to drive a movement of the counter pressure device 25 along the linear guide 30.

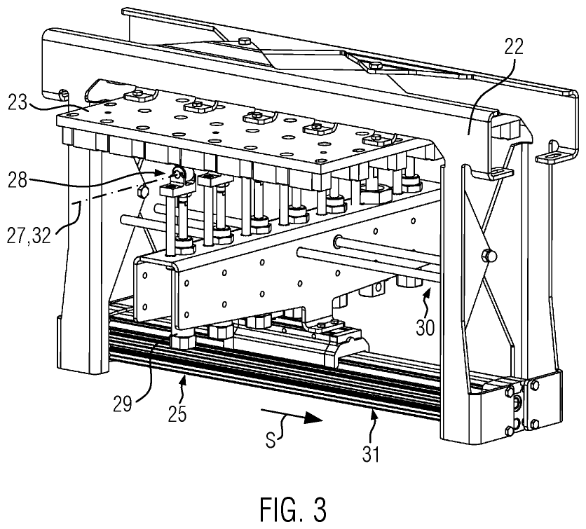

In FIG. 3, the same perspective as in FIG. 2 is shown. In this illustration the rollers 28 have been pressed against the knives 24 by the actuator 29 and the counter pressure device 25 has been shifted in the cutting direction S by the feeding actuator 31. The counter pressure device 25 may accordingly be shiftable in the cutting direction S. During the shifting, the counter pressure device 25, in particular the roller 28 may roll on the knife 24 with the curved surface 26. The rolling may occur about a rolling axis 32. As can be seen in the present embodiment, the curvature axis 27 and the rolling axis 32 may be oriented collinear with respect to each other. Since this may facilitate manufacturing of the curved surface 26, this is a preferred variant. However, the disclosure also encompasses variants, in which the curvature axis 27 and the rolling axis 32 are at least partially not oriented collinear. For example, the curvature axis 27 may only temporarily be oriented collinear to the rolling axis 32 and embodiments having an elliptically curved surface 26.

As can be seen in FIGS. 2 and 3 the rolling axis 32 may be oriented parallel to the working direction R. Alternatively or additionally, the rolling axis may be oriented transverse, preferably orthogonal, to the cutting direction S. As already mentioned, the rolling axis 32 may be oriented parallel, preferably collinear, to the curvature axis 27. As has will become more apparent in FIG. 4, the rolling axis 32 may be oriented transverse, preferably orthogonal, to a cutting edge 33 (see FIG. 4) of the knife 24. The pressing direction A may be oriented transverse, preferably orthogonal, to the working direction R and the cutting direction S.

In FIG. 4, a detailed view of components of the counter pressure device 25 is shown. The viewing direction in this case is opposite the cutting direction S. Now it can be seen that the knives 24 may have a cutting edge 33. The curved surface 26 may in particular be configured to roll on this cutting edge 33 of the knife 24. The cutting edge 33 and the curved surface 26 may contact one another at a contact surface 34 in the pressed state of the counter pressure device 25. The contact surface 34 may preferably be point-shaped. By rolling of the curved surface 26 on the cutting edge 33 by shifting the counter pressure device 25, the contact surface 34 may move along the cutting edge 33. The configuration presently described may have the effect that the actuator 29 only has to exert enough force to press the first film 8 and/or the second film 10 against the cutting edge 33 strong enough such that the first film and/or the second film 10 is severed in a portion, the area of which corresponds to the contact surface 34. This force may be substantially smaller than a force which is necessary to achieve a severance of the films by pressing them against the cutting edge 33 along its entire length simultaneously.

As indicated in FIG. 4, a plurality of rollers 28 may be provided. For the sake of brevity of the present description, several possible bearing variants for the roller 28 are shown in the detailed view of FIG. 4 which will be described in more detail in the following. However, it should be appreciated that the disclosure is also directed to variants, in which all of the rollers provided have identical bearings or any suitable combination of the bearing variants described in the following.

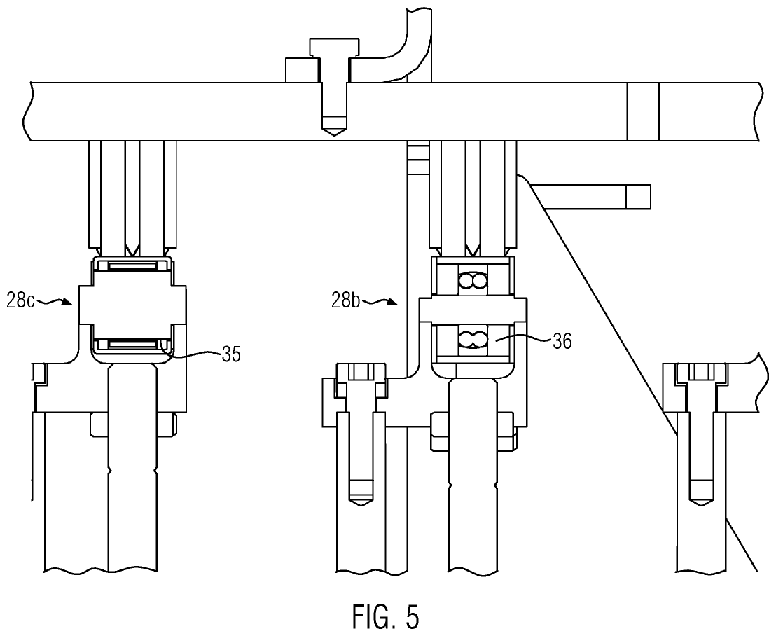

In FIG. 5, a sectional view of the view of FIG. 4 is shown. Two bearing variants, which are conceivable for use with one of the rollers 28, are illustrated referring to the rollers 28c and 28b from FIG. 4. In general, rolling bearings may be preferred for bearing the rollers 28. This may facilitate achieving a suitable rolling of the curved surface 26 on the cutting edge 33. A possible variant is illustrated with reference to the roller 28c. A simple needle roller bearing 35 may be used as a rolling bearing. As illustrated with reference to roller 28b, roller 28 may be supported by a self-aligning ball bearing. A self-aligning roller bearing is conceivable as well even though it is not illustrated. Such self-aligning bearings may compensate possible play, which may be present in the guiding of a piston rod of and actuator 29 embodied as a pneumatic cylinder. In this way, adequate contact between the roller 28 and the cutting edge 33 of the knife 24 may be maintained in a better way.

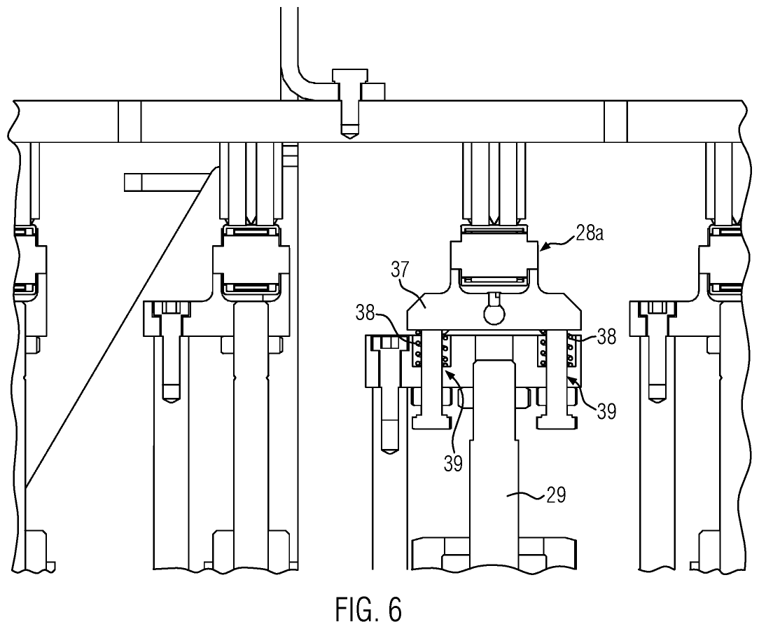

A further possibility to compensate for play is depicted in FIG. 6. As in the other bearing variants, the roller 28a is supported by a roller holder 37. As illustrated with reference to roller 28a, the roller holder 37 may also be articulated. For this purpose, it may for example be connected to the actuator 29 by two springs 38. Further, a spring guide 39 may be provided for each of the springs 38, the spring guides 39 guiding the movement of the roller holder 37.

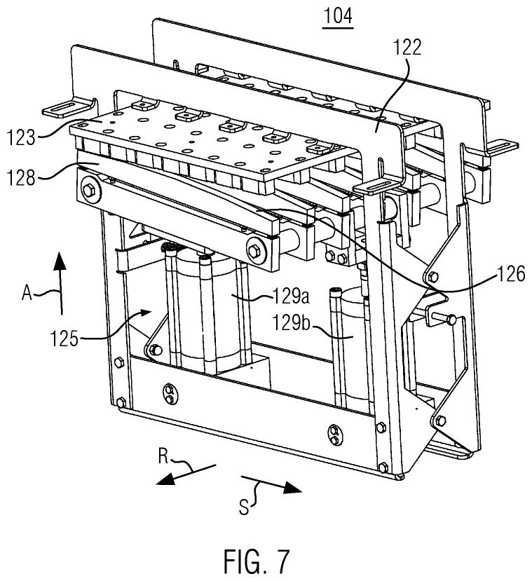

In the following, a further embodiment of a cutting station for will be explained with reference to FIGS. 7 to 12. A skilled person will recognize that some aspects of the previously described first embodiment are applicable to the second embodiment described in the following and that further aspects of the embodiment described in the following are applicable to the previously described first embodiment. However, for the sake of brevity, not every combination resulting from such applications will be explicitly explained. However, it should be appreciated that these are also encompassed by the disclosure.

In FIG. 7, the transverse cutting device 104, also referred to as cutting station 104, according to the second embodiment is shown perspectively. As shown, it may comprise a frame 122. Said frame 122 may allow for conveying the film 8 and/or a film composite comprising the first film 8 and the second film 10 in the working direction R through the frame 122. A knife plate 123 may be arranged at the frame 122. Said knife plate 123 may be configured to hold one or a plurality of knives 124 (see FIG. 4). The cutting station 104 may further comprise a counter pressure device 125. Depending on whether one or a plurality of knives 124 are provided, the one or the plurality of knives 124 and the counter pressure device 125 may be pressable against one another. The pressing may occur in a pressing direction A. The packaging machine 1, in particular the cutting station 104 may be configured such that the first film 8 and/or the second film 10 are conveyed between the knife 124 or the knives 124 and the counter pressure device 125. The cutting device 104 may be configured to press the first film 8 and/or the second film 10 against the knives 124 by pressing the counter pressure device 125 and the knives 124 against one another. Thereby, the first film 8 and/or the second film 10 may be severed.

The counter pressure device 125 may have a curved surface 126. The curved surface 126 may be curved around a curvature axis 127. The curvature may be circular or elliptical. As in the embodiment shown in FIG. 2, the curved surface 126 may be curved circular. As shown in the presently described embodiment, the curved surface 126 may be provided at a rocker 128. The counter pressure device 125 may comprise the rocker 128.

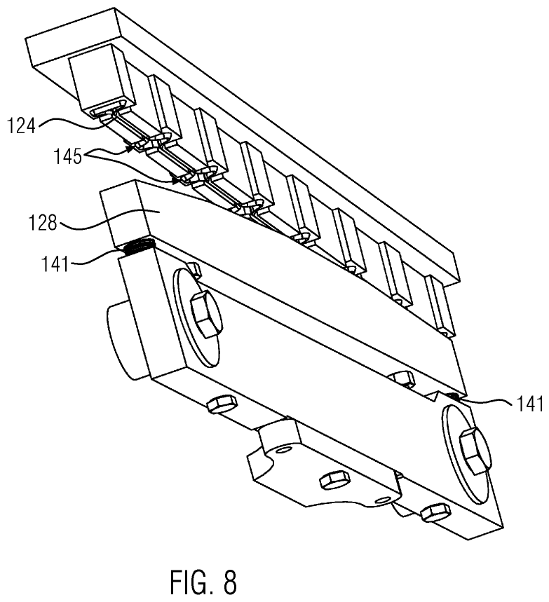

It should be appreciated that even though several knives 124 and several rockers 128 are provided in the present embodiment, cutting stations having only one knife 124 and/or only one rocker 128 are encompassed by the disclosure as well, as indicated in FIG. 8, for example.

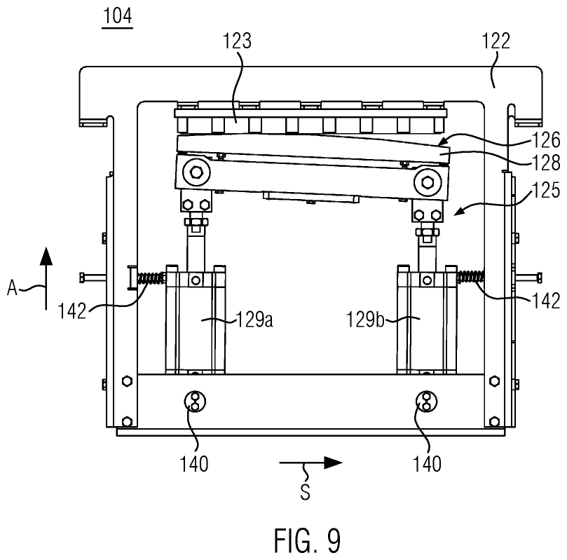

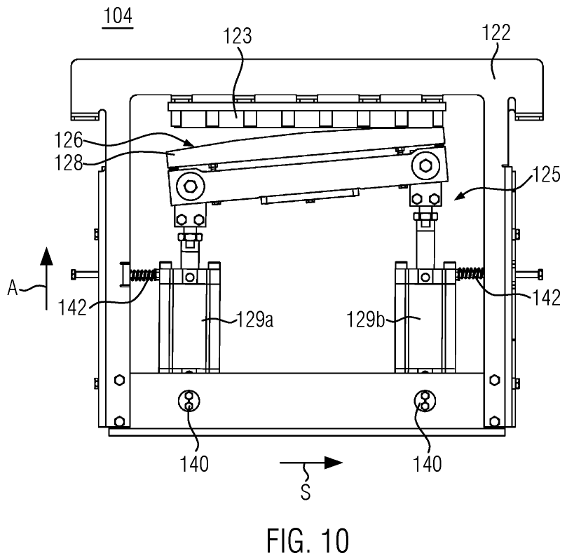

The counter pressure device 125, in particular the rocker 128 may be pressable against the knife 124. For this purpose, the counter pressure device 125 may, as in the presently described embodiment, comprise two actuators 129a, 129b. Both may be configured for pressing the rocker 128 against the knife 124. The actuators 129a, 129b may for example be pneumatic cylinders. The cutting station 104 for may be configured to sever the first film 8 and/or the second film 10 in a cutting direction S. For this purpose, a control unit, for example the control unit 18 of the packaging machine 1, may control actuators 129a, 129b such that the rocker at 128 rolls on the knife 124 in a rocking movement. This movement is illustrated in FIGS. 9 and 10.

In FIG. 8, the rocker 128 and the knife 124 are shown in a detailed perspective view. It becomes visible that the knife 124 may have so-called star portions 145. The latter may be configured to generate rounded transition edges on packaging flanges or borders, which may be disposed between transverse edges generated by transverse cutting devices 4, 104 and longitudinal edges generated by the longitudinal cutting devices 5 of the finished packages 21. A skilled person will recognize that star portions may be provided the knives 24 of the cutting station for from the 1st embodiment as well. The star portions 145 are examples for portions, in which the rolling axis 32 is not oriented transverse and/or orthogonal to the cutting edge 33 of the knife 24.

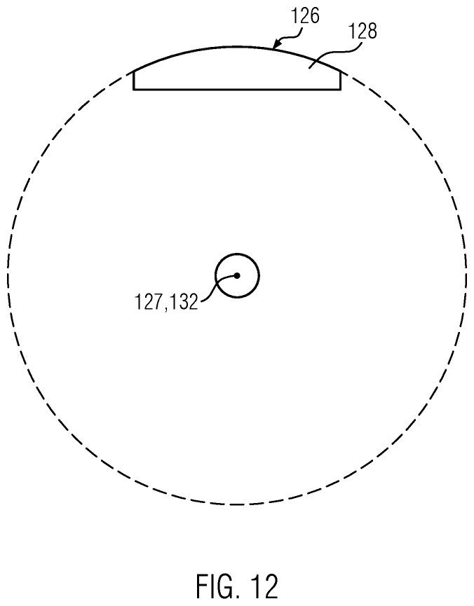

The rocker 128 rolls about a rolling axis 132 as well. Due to the amount of the radius of the curvature of the curved surface 126, the rolling axis 32 is only schematically depicted in FIG. 12. The same is analogously applicable to the curvature Axis 127, around which the curved surface 126 is curved.

Further, compensating springs 141 can be seen in FIG. 8. Said compensating springs 141 may be connected to the rocker 128. Thereby, tolerances in the rocking movement may be compensated for. The compensating springs 141 may, therefore, fulfill a similar function as the self-aligning bearings 36 or of the roller holders 37 being supported in an articulated way from the first embodiment.

In FIGS. 9 and 10, the cutting station 104 is shown from a perspective opposite to the working direction R. Therein, FIG. 9 shows the state at the beginning of the rocking movement, in which the rocker 128 rolls on the knife 124 with the curved surface 126. The actuators 129a, 129b may be supported at the frame 122 in an articulated way, for example by supporting bolts 140. This may enable a pivoting of the actuators 129a, 129b, whereby, in particular through the reduction of slippage, inadequate rolling of the curved surface 126 on the knives 124 may be achieved. Further, centering devices 142 may be disposed at frame 122. The latter may prevent excessive tilting of the articulated actuators 129a, 129b on one hand. On the other hand, the counter pressure device 125 may be centered and/or aligned to the knife plate 123.

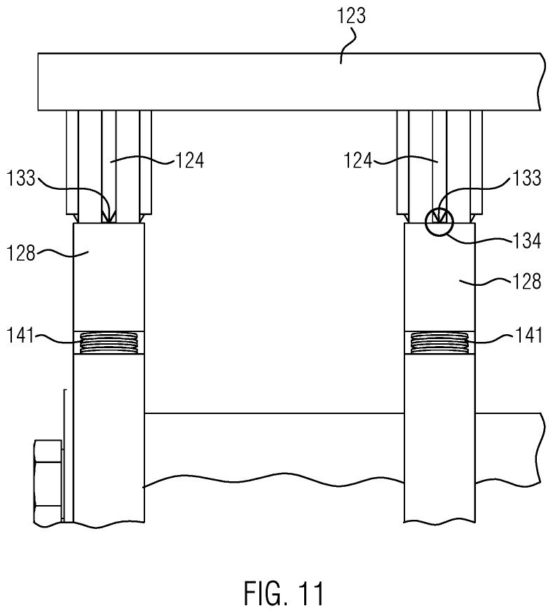

In FIG. 11, a detailed view of two of the rockers is shown from a perspective opposite to the cutting direction S. Here, the cutting edge 133 of the knife 124 as well as the contact surface 134, at which the cutting edge 133 and the rocker 128 may contact each other, can be better seen.

All of the embodiments previously described with reference to the figures relate to variants, in which the knife plate 23, 123 are disposed in movably with respect to the frame 22, 122 and the counter pressure device 25, 125 is moved in order to press the knife 24, 124 and the counter pressure device 25, 125 against one another. The disclosure encompasses variants, in which a knife plate is disposed movably and a counter pressure device is immovable with respect to the frame.

What is claimed is:

1. A packaging machine having a plurality of working stations for processing a film, at least one of the working stations being a cutting station, wherein the working stations are disposed successively along a working direction and the film is conveyed in the working direction from a first one of the working stations to a second one of the working stations, wherein the cutting station is configured to sever the film in a cutting direction, which is oriented transverse with respect to the working direction, wherein the cutting station has a knife and a counter pressure device, which are pressable against one another in a pressing direction,
wherein the counter pressure device has a curved surface, which is curved around a curvature axis, and the counter pressure device is configured to roll on a cutting edge of the knife about a rolling axis with the curved surface.

2. The packaging machine according to claim 1, wherein the rolling axis is at least partially oriented parallel to the working direction.

3. The packaging machine according to claim 1, wherein the rolling axis is at least partially oriented orthogonal to the cutting edge.

4. The packaging machine according to claim 1, wherein the rolling axis is oriented parallel to the curvature axis.

5. The packaging machine according to claim 1, wherein the rolling axis is oriented collinear to the curvature axis.

6. The packaging machine according to claim 1, wherein the knife is immovable in the pressing direction with respect to the film.

7. The packaging machine according to claim 1, wherein a contact surface between the curved surface and the cutting edge is point-shaped during rolling.

8. The packaging machine according to claim 1, wherein a contact surface between the curved surface and the cutting edge moves along the cutting edge during rolling.

9. The packaging machine according to claim 1, wherein the pressing direction is oriented orthogonal with respect to the working direction and the cutting direction.

10. The packaging machine according to claim 1, wherein the counter pressure device is configured such that the rolling axis moves relative to the knife during rolling.

11. The packaging machine according to claim 1, wherein the counter pressure device comprises a roller, on which the curved surface is provided.

12. The packaging machine according to claim 11, wherein the counter pressure device has an actuator, which is configured to press the roller against the knife.

13. The packaging machine according to claim 11, wherein the counter pressure device is movable transverse to the working direction.

14. The packaging machine according to claim 1, wherein the counter pressure device comprises a rocker, on which the curved surface is provided.

15. The packaging machine according to claim 14, wherein the counter pressure device has two actuators, which are configured to press the rocker against the knife.

16. The packaging machine according to claim 1, wherein the cutting direction is oriented orthogonal with respect to the working direction.

17. A packaging machine comprising:
a plurality of working stations for processing a film, with at least one of the working stations being a cutting station,
the working stations being disposed successively along a working direction to enable the film to be conveyed in the working direction from a first one of the working stations to a second one of the working stations,
the cutting station configured to sever the film in a cutting direction oriented transverse with respect to the working direction, wherein the cutting station has a knife and a counter pressure device, which are pressable against one another in a pressing direction,
wherein the counter pressure device has a curved surface, which is curved around a curvature axis, and the counter pressure device is configured to roll on a cutting edge of the knife about a rolling axis with the curved surface.
